(19) United States
(12) Patent Application Publication
(10) Pub. No.: US 2026/0243388 A1
(43) Pub. Date: Aug. 20, 2026

(54) TARGET CALIBRATION STAND

(71) Applicant: Justin Proctor, Montgomery, AL (US)

(72) Inventor: Justin Proctor, Montgomery, AL (US)

(21) Appl. No.: 19/469,468

(22) PCT Filed: Mar. 27, 2024
(86) PCT No.: PCT/US2024/021550

§ 371 Date: Sep. 26, 2025

Related U.S. Application Data
(60) Provisional application No. 63/454,831, filed on Mar. 27, 2023.

(51) Int. Cl. F16M 11/26; F16M 11/04; G01D 18/00

(52) U.S. Cl. CPC F16M 11/26; F16M 11/04; G01D 18/00

(57) ABSTRACT

Apparatus and methods of using a target calibration stand to support calibration targets having different dimensions are disclosed herein. In one aspect, the method includes adjusting calibration stand height until the target calibration stand reaches a height specified by a manufacturer of a vehicle to undergo a calibration session, positioning first and second main arms so that first and second arm angles each measure about ninety degrees, positioning first and second auxiliary arms so that first and second auxiliary angles each measure about ninety degrees, mounting a first calibration target onto first and second target mount assemblies, removing the first calibration target from the target calibration stand, positioning the first and second auxiliary arms so that the first and second auxiliary angles each measure about zero degrees, and mounting a second calibration target onto the first and second target mount assemblies.

### TECHNICAL FIELD

This disclosure relates to calibration and re-calibration technology for automobiles. More specifically, this disclosure relates to a universal stand that can support a large variety of different targets corresponding to Advanced Driver Assistance Systems (ADAS) units embodied in automobiles originating from various manufacturers.

### BACKGROUND

The highways of the United States, and the world, have proven a dangerous and costly mode of transportation. The peak of deaths resulting from automobile accidents occurred in 1972, according to the National Highway Safety Traffic Administration (NHSTA), with a reported 54,589 deaths. The loss of life due to automotive design was unacceptable. Through a combination of legislation and consumer activism, automobile manufacturers were forced to confront the challenge of creating a safer automobile for public use, resulting in reduction of traffic fatalities. Initially, these changes focused on construction of the vehicle itself, with minor innovations of better windshield wipers, mirrors, seat belts, and the introduction of secondary safety devices, such as airbags and seatbelt pretensioners. Later progress included more advanced designs incorporating crush zones, passenger compartment energy dispersal, and advanced steel construction using custom-made blanks and combinations of light-weight alloys and Ultra High Strength Steels, resulting in automobiles that enhanced survivability of collisions with other vehicles, pedestrians, and stationary objects.

The automobile industry then evolved further to focus on avoiding collisions altogether. With the advancement of inexpensive high tech electrical components, this new phase of consumer safety saw the advent and implementation of Advanced Driver Assistance Systems (ADAS). An ADAS may incorporate several technologies to assist a driver with collision avoidance, including cameras, sonar, radar, Bluetooth®, and LIDAR (standing for Light Detection and Ranging or Laser Imaging, Detection, and Ranging). ADAS technology can be implemented in multiple ways. For example, camera systems can provide a driver with a 360° view of the outside of the vehicle, enhancing visibility of children, animals, and fixed objects that would otherwise be outside of the driver's field of view. For further example, many manufacturers install cameras in several areas, including the windshield itself, for “Lane Watch” assistance that helps the driver to stay between the lines. Still further, camera systems can be utilized for self-automation of the vehicle itself, as demonstrated by Tesla® automobiles that fully integrate optical cameras to provide data to algorithms that autonomously drive the vehicle.

ADAS technology rapidly developed, such that implementation of the equipment has spread from solely high-end luxury vehicles to now include base models. Despite the wider implementation of ADAS technology, it has not eliminated accidents altogether. Human interaction and aging vehicles not equipped with ADAS technology are still a factor in collisions. Nevertheless, ADAS technology can still reduce collision incidents and severity.

When a collision does occur, maintenance of an ADAS creates a new level of responsibility and liability for the repair facility. A crucial aspect of this responsibility concerns post-collision repair and calibration of the ADAS, which means to set (verify function, aim, and test) the reference point for a given element (called a module) in the ADAS. Such modules must sometimes be calibrated in a post-collision repair, due to the jolt of the collision. Examples of an ADAS module include, but are not limited to, a front peripheral camera, a lane assist module, and a parking aid control module. Modules that are removed and reinstalled need a new reference point established due to no longer being mounted at the exact same angle/location as previously, as a result of a collision and reinstallation. New modules need a reference point established as well. Stated differently, the objective of a calibration session is to ensure that an ADAS module knows where it is in relation to everything else. The reference point allows the vehicle's computer system to determine that the positioning of the sensors is within a vehicle manufacturer's specifications.

In the repair industry, millimeters matter. For instance, if a shop repairs and replaces a front radar unit on a vehicle and fails to calibrate the radar unit in a manner specified by the vehicle manufacturer, the shop may then release to a customer a vehicle that fails to recognize dangers in the road. Calibration procedure deviations can even cause a radar-based ADAS to scan oncoming traffic instead of scanning traffic in front of the vehicle for purposes of slowing or braking. Other examples of consequences of failing to properly calibrate an ADAS are too numerous to list in the present application.

ADAS module calibrations utilize multiple methods, including but not limited to fixed stationary targeting, programming, and dynamic over-the-road calibration of components. The type of ADAS calibration performed depends upon the type of ADAS module and the recalibration criteria set by the vehicle manufacturer. Bluetooth® modules typically do not require a calibration. Only a limited number of vehicle models require calibration (resetting) of sonar modules, and in such instances, calibration is done with use of a jig rather than a calibration stand.

Regarding the remaining types of ADAS modules (namely camera/radar/LIDAR modules), calibration is performed by fixed stationary targeting. This calibration method requires use of a target, which is a physical object that a camera/radar/LIDAR module recognizes to set, or to reset, a reference point. Cameras use visual targets, which are printed targets that the camera recognizes. Radar module calibration requires physical targets that reflect radar waves in a certain way so that the vehicle understands the positioning of the radar unit. Radar targets are made to reflect radar in a certain way that a module recognizes. Similarly, LIDAR targets use a reflective material that reflects the laser/light in a certain way that the vehicle understands the positioning of the LIDAR unit. The targets can be comprised of either a flexible material or a rigid material, depending upon a customer's preferences. Flexible targets can be made from a blackout vinyl, for example.

Even considering just a fixed stationary targeting calibration method, calibration steps can still vary significantly depending upon the vehicle manufacturer. However, using as an example a procedure followed for calibrating a front radar ADAS module for Audi/Volkswagen vehicles, listing certain steps provides greater context for generally understanding the function of target calibration stands, and for introducing certain terminology applicable to a calibration procedure.
1. Locate the radar units from service information for the vehicle. Referring to FIG. 1 for this example, vehicle 10 has front radar units 12-16, specifically, a center radar unit 12, left side radar units 13,14, and right side radar units 15,16.
2. Obtain vehicle centerline 11. To calibrate the front radar units 12-16, this may be done by using a plumb bob to make two markings on the shop floor: a first point corresponding to the center of the front of the vehicle 10, using the front vehicle emblem as a reference, and a second point corresponding to the center of the rear of the vehicle, using the rear vehicle emblem as a reference. Then, using either a string or a laser, a line is formed to connect the points on the floor, and the line is extended a minimum of 500 cm (197 inches) past the first point. At the extended distance, a third point is marked, and the extended segment of the centerline 11 provides a reference line for use of a calibration target stand, introduced at Step 5 below. This same centerline determination procedure is followed for calibration of rear radar units (not shown), except that the centerline 11 is extended the same distance past the second point instead of the first point to arrive at the third point to be marked.
3. Remove the emblem cover as to the center radar unit 12, and remove bezels covering the remaining front radar units 13-16.
4. Perform a visual inspection of the front radar units 12-16 to determine whether to manually adjust any of the units. Many of these radar units will have become dislodged, during a collision, from the vehicle bracket on which they were mounted. The center radar unit 12 sits at 90° both vertically and horizontally, while the remaining radar units 13-16 sit at a slight angle with respect to the centerline 11.
5. Using a target calibration stand with the appropriate target mount assembled on it, position the target with respect to the radar unit to be calibrated. In this example, the target is placed directly in front of the radar unit at a distance of approximately 120 cm to 130 cm. Furthermore, the target is oriented at 90° to the centerline 11.
6. Adjust the height of the calibration stand to correspond to a target height that matches the center of the radar unit.
7. Using a scan tool, locate the appropriate calibration program. A scan tool is either a standalone aftermarket tablet sold by a vehicle manufacturer, the tablet containing calibration software customized for the vehicle, or a laptop on which factory software is loaded. Factory software can be loaded onto a single laptop if configured to use virtual machines or if the laptop hard drive is partitioned. This must be done because some factory software has conflicts with other factory software. Additionally, a single aftermarket tablet may contain software that can perform calibrations for several vehicle manufacturers.
8. Use the located calibration program (scan tool software) to execute the calibration of the radar unit. In the present example, the scan tool software for Audi/Volkswagen vehicles is known as Off-Board Diagnostic Information System Service (ODIS). Each radar unit 12-16 in FIG. 1 is a “Distance Regulation Control Module,” as that term appears in ODIS. For radar modules, calibration includes using a Doppler unit, which is a device that uses doppler to simulate a vehicle in the blind spot area of the vehicle 10. An example of a commercially available Doppler unit is a Doppler simulator sold as part of a lane change calibration tool sold by Audi/Volkswagen AG under Model No. VAS6350/4.

Each vehicle manufacturer publishes an original equipment manufacturer (OEM) calibration process, including prescribing particular sizes and configurations of targets needed for calibration of camera/radar/LIDAR modules. For example, and not by way of limitation, FIG. 2A illustrates a target 20 used for a particular Audi/Volkswagen vehicle, while FIG. 2B illustrates a target 22 used for a particular Honda vehicle. However, many aftermarket manufacturers sell a custom equipment package, including a calibration stand, that does not follow the published calibration process but works differently according to reengineered specifications. Under the reengineered specifications, target sizes deviate from the published OEM calibration process, and reference points are changed in order to “trick” the camera/radar/LIDAR module into thinking the targets are the OEM size placed at the reference point defined in the published OEM calibration process. This is a problem because these systems are calibrated based on reference points. Furthermore, these reengineered calibration specifications are provided on a scan tool, to be used with custom target calibration stands for holding the custom targets. Buying these items from multiple manufacturers is expensive.

### SUMMARY OF THE INVENTION

It is to be understood that this summary is not an extensive overview of the disclosure. This summary is exemplary and not restrictive, and it is intended to neither identify key or critical elements of the disclosure nor delineate the scope thereof. The sole purpose of this summary is to explain and exemplify certain concepts of the disclosure as an introduction to the following complete and extensive detailed description.

In an aspect of the present disclosure, a target calibration stand can comprise a main mast, the main mast defining a cavity; a secondary mast slidably received within the cavity of the main mast, the secondary mast defining an upper end and a secondary mast axis; a link bracket defining a first end, an opposed second end, and a body portion disposed between the first end and the second end, the body portion connected to the upper end of the secondary mast, the link bracket defining a first pivotal mount proximate the first end and a second pivotal mount proximate the second end; a first main arm, the first main arm defining a first main arm axis, a first proximal end, a first free end opposite the first proximal end, and a first top surface extending between the first proximal end and the first free end, the first main arm connected at the first proximal end to the first pivotal mount of the link bracket, wherein the first main arm is pivotable about the first pivotal mount in a vertical plane to allow variance of a first arm angle between the first main arm axis and the secondary mast axis; a second main arm, the second main arm defining a second main arm axis, a second proximal end, a second free end opposite the second proximal end, and a second top surface extending between the second proximal end and the second free end, the second main arm connected at the second proximal end to the second pivotal mount of the link bracket, wherein the second main arm is pivotable about the second pivotal mount in the vertical plane to allow variance of a second arm angle between the second main arm axis and the secondary mast axis; a first pivot assembly, the first pivot assembly selectively positionable on the first top surface of the first main arm; a first auxiliary arm, the first auxiliary arm defining a first auxiliary axis, a first auxiliary proximal end, a first auxiliary distal end opposite the first auxiliary proximal end, and a first auxiliary outer surface extending between the first auxiliary proximal end and the first auxiliary distal end, the first auxiliary proximal end mounted to the first pivot assembly such that the first auxiliary arm is pivotable about the first pivot assembly in the vertical plane to allow variance of a first auxiliary angle between the first auxiliary axis and the first main arm axis; a first target mount assembly, the first target mount assembly selectively positionable on the first auxiliary outer surface, the first target mount assembly configured to support a calibration target by engaging a first portion of the calibration target; a second pivot assembly, the second pivot assembly selectively positionable on the second top surface of the second main arm; a second auxiliary arm, the second auxiliary arm defining a second auxiliary axis, a second auxiliary proximal end, a second auxiliary distal end opposite the second auxiliary proximal end, and a second auxiliary outer surface extending between the second auxiliary proximal end and the second auxiliary distal end, the second auxiliary proximal end mounted to the second pivot assembly such that the second auxiliary arm is pivotable about the second pivot assembly in the vertical plane to allow variance of a second auxiliary angle between the second auxiliary axis and the second main arm axis; and a second target mount assembly, the second target mount assembly selectively positionable on the second auxiliary outer surface, the second target mount assembly configured to support the calibration target by engaging a second portion of the calibration target.

In another aspect of the present disclosure, a method of using the above-described target calibration stand to sequentially support a first calibration target for a first calibration session and then a second calibration target for a second calibration session, wherein a configuration of the second calibration target differs from a configuration of the first calibration target, may comprise the steps of adjusting a height of the calibration stand by telescopically moving the secondary mast in a vertical direction with respect to the main mast until the target calibration stand reaches a first height specified by a manufacturer of a vehicle to undergo calibration in the first calibration session; positioning the first main arm and the second main arm so that the first arm angle and the second arm angle each measure about ninety degrees; positioning the first auxiliary arm and the second auxiliary arm so that the first auxiliary angle and the second auxiliary angle each measure about zero degrees; mounting the first calibration target onto the first target mount assembly and onto the second target mount assembly; removing the first calibration target from the target calibration stand; positioning the first auxiliary arm and the second auxiliary arm so that the first auxiliary angle and the second auxiliary angle each measure about ninety degrees; and mounting the second calibration target onto the first target mount assembly and onto the second target mount assembly.

Various implementations described in the present disclosure can comprise additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims. The features and advantages of such implementations can be realized and obtained by means of the systems, methods, features particularly pointed out in the appended claims. These and other features will become more fully apparent from the following description and appended claims, or can be learned by the practice of such exemplary implementations as set forth hereinafter.

### BRIEF DESCRIPTION OF THE DRAWINGS

The features and components of the following figures are illustrated to emphasize the general principles of the present disclosure. Corresponding features and components throughout the figures can be designated by matching reference characters for the sake of consistency and clarity.

FIG. 1 is a top view of a vehicle and a centerline thereof.

FIG. 2A is a front view of an exemplary calibration target used for a vehicle.

FIG. 2B is a front view of another exemplary calibration target used for a vehicle.

FIG. 3 is a front elevation view of a target calibration stand constructed in accordance with aspects of the present disclosure, the stand shown in a fully collapsed position.

FIG. 4 is a front perspective view of a target calibration stand constructed in accordance with aspects of the present disclosure, the stand shown in a partially expanded position.

FIG. 5 is an end view of a main mast of the target calibration stand constructed in accordance with aspects of the present disclosure.

FIG. 6A is an end view of a secondary mast of the target calibration stand constructed in accordance with aspects of the present disclosure.

FIG. 6B is a side view of the secondary mast of the target calibration stand constructed in accordance with aspects of the present disclosure.

FIG. 7A is an end view of a main arm of the target calibration stand constructed in accordance with aspects of the present disclosure.

FIG. 7B is a side view of a main arm of the target calibration stand constructed in accordance with aspects of the present disclosure.

FIG. 8 is a front elevation view of the target calibration stand constructed in accordance with aspects of the present disclosure, the stand shown in a partially open position.

FIG. 9 is a front elevation view of the target calibration stand constructed in accordance with aspects of the present disclosure, the stand shown in a further partially opened position compared to that of FIG. 8.

FIG. 10 is a front elevation view of the target calibration stand constructed in accordance with aspects of the present disclosure, the stand shown in a first fully-opened position.

FIG. 11 is a front elevation view of the target calibration stand constructed in accordance with aspects of the present disclosure, the stand shown in a second fully-opened position.

FIG. 12 is an enlarged top perspective view of a link bracket constructed in accordance with aspects of the present disclosure.

FIG. 13 is an enlarged front perspective view of second and fourth pivot assemblies constructed in accordance with aspects of the present disclosure.

FIG. 14 is an enlarged front perspective view of a second target mount assembly constructed in accordance with aspects of the present disclosure.

FIG. 15 shows the exemplary calibration target of FIG. 2A mounted on the target calibration stand in the first fully-opened position of FIG. 10.

FIG. 16 shows the exemplary calibration target of FIG. 2B mounted on the target calibration stand in the second fully-opened position of FIG. 11.

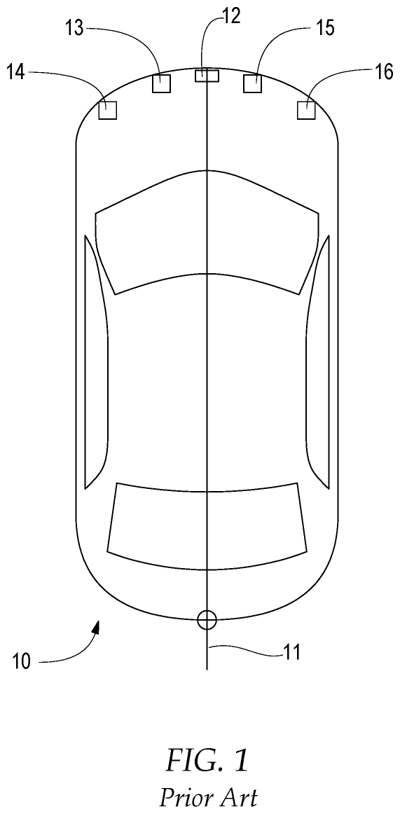

### DETAILED DESCRIPTION OF THE INVENTION

The present application claims priority to and benefit of U.S. Provisional Patent Application No. 63/454,831 filed on Mar. 27, 2023, the disclosure of which is incorporated herein by reference in its entirety.

The present disclosure can be understood more readily by reference to the following detailed description, examples, drawings, and claims, and their previous and following description. However, before the present devices, systems, and/or methods are disclosed and described, it is to be understood that this disclosure is not limited to the specific devices, systems, and/or methods disclosed unless otherwise specified, as such can, of course, vary. It is also to be understood that the terminology used herein is for the purpose of describing particular aspects only and is not intended to be limiting.

The following description is provided as an enabling teaching of the present devices, systems, and/or methods in their best, currently known aspect. To this end, those skilled in the relevant art will recognize and appreciate that many changes can be made to the various aspects described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

Reference numerals common to more than one accompanying figure identify the same component throughout the figures.

As used throughout, the singular forms “a,” “an” and “the” include plural referents unless the context clearly dictates otherwise. Thus, for example, reference to a quantity of one of a particular element can comprise two or more such elements unless the context indicates otherwise.

Ranges can be expressed herein as from “about” one particular value, and/or to “about” another particular value. When such a range is expressed, another aspect comprises from the one particular value and/or to the other particular value. Similarly, when values are expressed as approximations, by use of the antecedent “about” or “substantially,” it will be understood that the particular value forms another aspect. It will be further understood that the endpoints of each of the ranges are significant both in relation to the other endpoint, and independently of the other endpoint.

For purposes of the present disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes and between different models, the tolerance for a particular measurement of a particular component can fall within a range of tolerances.

As used herein, the terms “optional” or “optionally” mean that the subsequently described event or circumstance may or may not occur, and that the description comprises instances where said event or circumstance occurs and instances where it does not.

The word “or” as used herein means any one member of a particular list and also comprises any combination of members of that list.

To simplify the description of various elements disclosed herein, the conventions of “top,” “bottom,” “side,” “upper,” “lower,” “horizontal,” and/or “vertical” may be referenced. Unless stated otherwise, “top” describes that side of the system or component that is facing upward and “bottom” is that side of the system or component that is opposite or distal the top of the system or component and is facing downward. Unless stated otherwise, “side” describes that an end or direction of the system or component facing in horizontal direction. “Horizontal” or “horizontal orientation” describes that which is in a plane aligned with the horizon. “Vertical” or “vertical orientation” describes that which is in a plane that is angled at 90 degrees to the horizontal.

An aftermarket calibration stand that complies with OEM requirements is needed in the marketplace. This ensures that third-party vendors can provide OEM quality calibrations with an aftermarket tool. No aftermarket vendor has developed a solution that is able to complete ADAS calibrations using OEM service manuals.

Disclosed is a target calibration stand 100 that can overcome the aforementioned drawbacks of the prior art. The disclosed target calibration stand 100 allows calibrations to be completed the way the manufacturer intended by using the manufacturers' targets and published OEM calibration processes to dispense with having to buy the manufacturer's custom stand and software loaded computer. The adjustable features of the disclosed stand 100 allow a user to require only a single stand for calibrating a multitude of vehicles originating from many different manufacturers. The stand 100 can calibrate front radar, blind spots, and front facing camera calibrations. The stand 100 can integrate OEM doppler units for doppler calibrations as well.

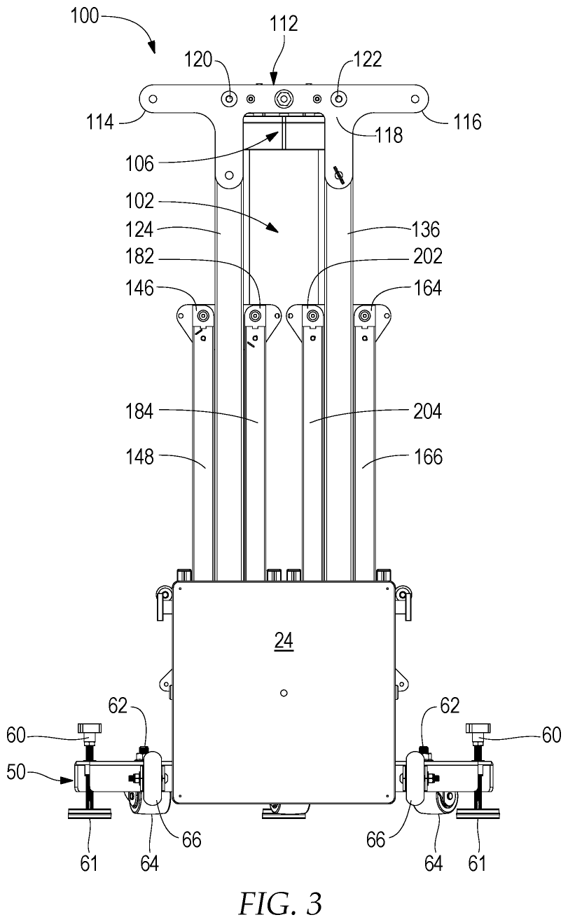

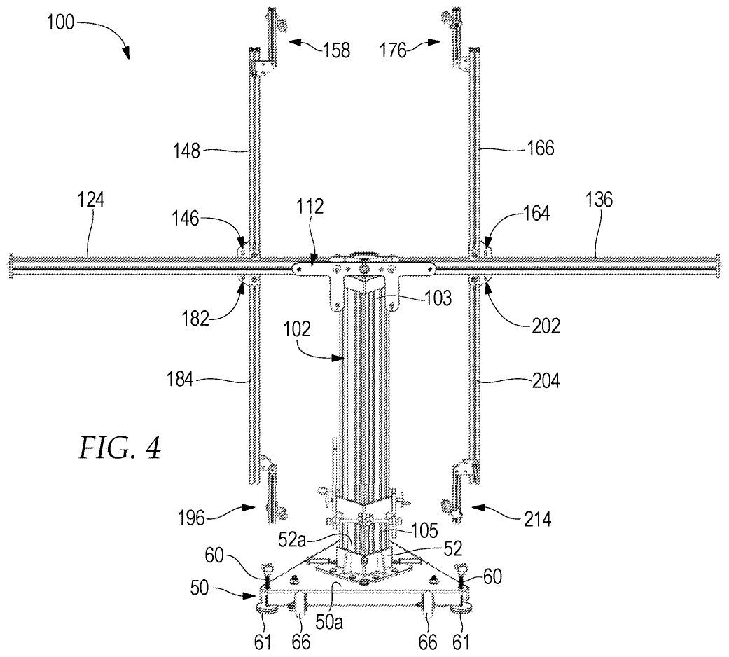

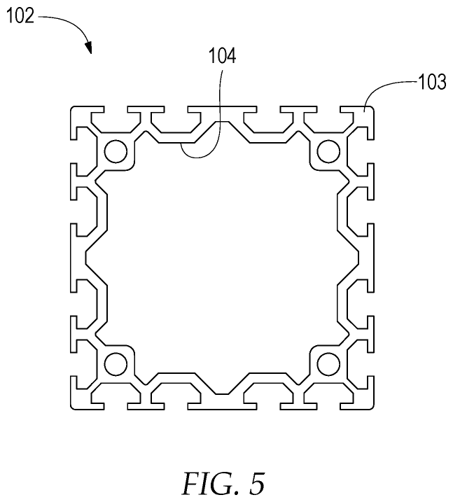

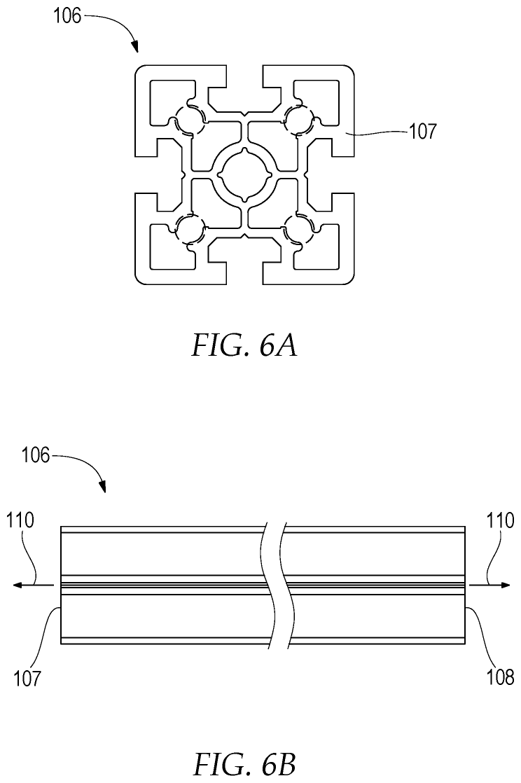

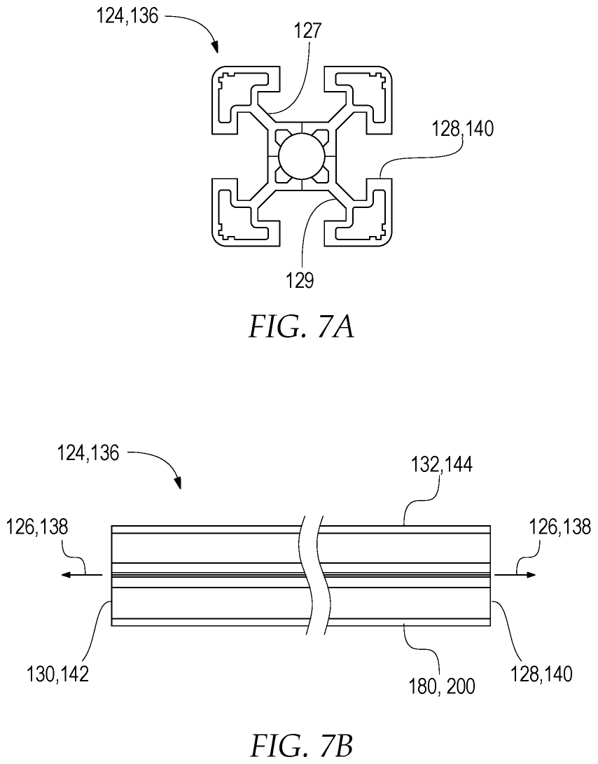

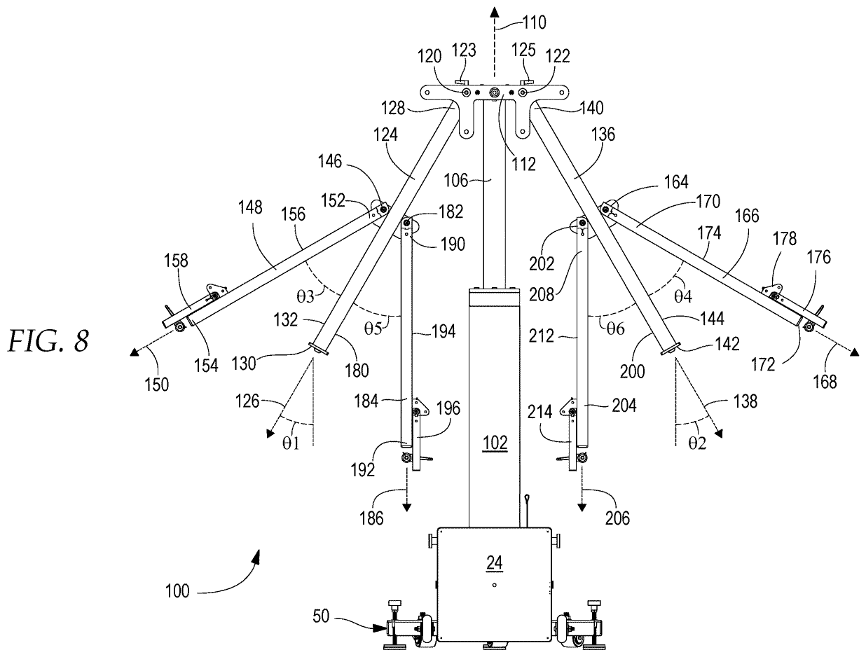

Referring to FIGS. 3-16, FIG. 3 illustrates a target calibration stand 100 constructed in accordance with aspects of the present disclosure in a fully collapsed position; FIG. 4 illustrates a target calibration stand 100 constructed in accordance with aspects of the present disclosure in a partially expanded position; FIG. 5 is an end view of a main mast 102 of a target calibration stand 100; FIG. 6A is an end view of a secondary mast 106 of a target calibration stand 100; FIG. 6B is a side view of the secondary mast 106 of a target calibration stand 100; FIG. 7A is an end view of a main arm 124,136 of a target calibration stand 100; and FIG. 7B is a side view of a main arm 124,136 of a target calibration stand 100. FIG. 8 is a front elevational view of the target calibration stand 100, illustrating the stand 100 in a partially opened position.

The target calibration stand 100 may comprise a main mast 102 defining an upper end 103, a lower end 105 opposite the upper end 103, and a cavity 104 defined in the main mast 102. A secondary mast 106 is slidably received within the cavity 104 of the main mast 102. The secondary mast 106 defines an upper end 107, an opposed lower end 108, and a secondary mast axis 110. The secondary mast 106 may be interconnected via a link bracket 112 to a first main arm 124 and to a second main arm 136 in a manner to be described. These components, together with auxiliary arms connected to the main arms 124, 136 in a manner to be described, may form a mast-arm subassembly. The stand 100 may further comprise a base subassembly which, in turn, comprises a base member 50 that may assume a substantially triangular shape as shown but that may assume any other suitable polygonal shape. Base member 50 defines an upper surface 50a to which is affixed a base mount 52 by any suitable means such as, for example, by a plurality of fasteners. The base mount 52 defines an opening 52a suitably sized to snugly receive the lower end 105 of the main mast 102. A locking mechanism may be mounted to the base mount 52 to lock the mast-arm assembly into place following insertion of the lower end 105 into the opening 52a. The base subassembly may further comprise a plurality of telescoping feet 61, each of which may be raised or lowered via a rotatable screw assembly 60 to secure the stand 100 in place. The base subassembly may further comprise caster pins 62 connected to respective caster wheel assemblies 64 so that the stand 100 may be easily moved around. The base subassembly may further comprise one or more wheels 66 so that the stand 100 may be easily moved around. A radar target 24 may be mounted to the main mast 102.

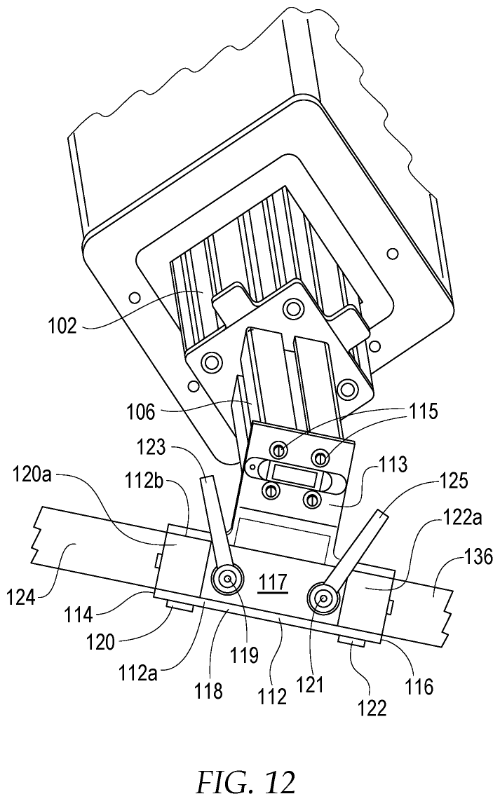

The link bracket 112 comprises a front flange 112a (FIG. 12) defining a first end 114, an opposed second end 116, and a body portion 118 disposed between the first end 114 and the second end 116. The link bracket 112 may further comprise a rear flange 112b (FIG. 12) interconnected to the front flange 112a by a bottom web (not shown) of the link bracket 112. A portion of the rear flange 112b may extend rearwardly to form a mounting plate 113 defining a plurality of apertures (not shown) through which respective fasteners 115 may extend to fasten the link bracket 112 to the upper end 107 (FIG. 6A) of the secondary mast 106. The fasteners 115 (four of them shown in FIG. 12) may comprise any suitable hardware, including but not limited to bolts, screws, and the like, for attaching the link bracket 112 to the upper end 107 of the secondary mast 106. The link bracket 112 may further define a first pivotal mount 120 proximate the first end 114 of the front flange 112a and a second pivotal mount 122 proximate the second end 116 of the front flange 112a. The first pivotal mount 120 may comprise a first collar 120a (FIG. 12) pivotable about a bolt extending through the front flange 112a, the first collar 120a, and the rear flange 112b. The first collar 120a may receive a proximal end 128 of a first main arm 124 (FIG. 7B), such that the first main arm 124 may pivot within the first collar 120a about the bolt extending through the first collar 120a. Similarly, the second pivotal mount 122 may comprise a second collar 122a (FIG. 12) pivotable about a bolt extending through the front flange 112a, the second collar 122a, and the rear flange 112b. The second collar 122a may receive a proximal end 140 of the second main arm 136 (FIG. 7B), such that the second main arm 136 may pivot within the second collar 122a about the bolt extending through the second collar 122a.

FIG. 12 illustrates the remaining primary components associated with the link bracket 112. The front flange 112a and the rear flange 112b of the link bracket 112 may support a bearing plate 117 defining at least one aperture (not shown) through which at least a respective tensioning element extends, with FIG. 12 illustrating tensioning elements 119, 121, which may both be, for example, bolts. A first tensioning lever 123 may engage the first tensioning element 119 to fix the first main arm 124 in a selected rotational position upon rotation of the first tensioning lever 123 in one direction, and to release the first main arm 124 from that selected rotational position upon rotation of the first tensioning lever 123 in an opposite direction. Similarly, a second tensioning lever 125 may engage the second tensioning element 121 to fix the second main arm 136 in a selected rotational position upon rotation of the second tensioning lever 125 in one direction, and to release the second main arm 136 from that selected rotational position upon rotation of the second tensioning lever 125 in an opposite direction.

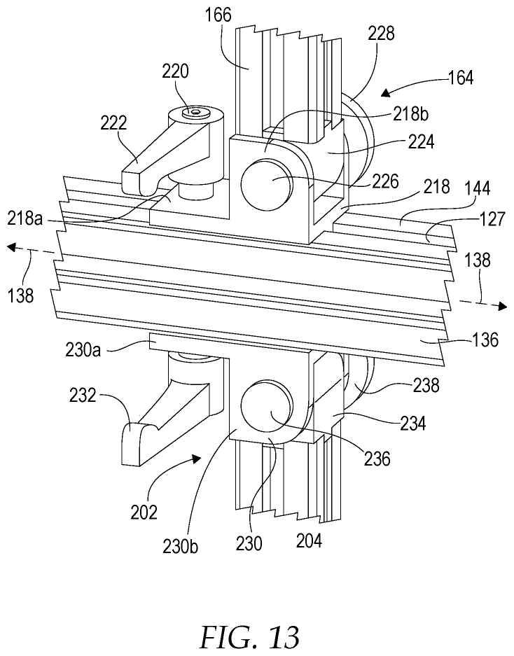

Referring to FIGS. 3-8, the first main arm 124 defines a first main arm axis 126, a first proximal end 128, a first free end 130 opposite the first proximal end 128, and a first top surface 132 extending between the first proximal end 128 and the first free end 130. The first main arm 124 is connected at the first proximal end 128 to the first pivotal mount 120 of the link bracket 112, as described above with regard to FIG. 12. The first main arm 124 is therefore pivotable about the first pivotal mount 120 in a vertical plane (i.e., the plane of the drawing sheet in FIG. 8) to allow variance of a first arm angle Θ₁ between the first main arm axis 126 and the secondary mast axis 110. The stand 100 also includes the second main arm 136, which may be constructed identically to the first main arm 124. The second main arm 136 defines a second main arm axis 138, a second proximal end 140, a second free end 142 opposite the second proximal end 140, and a second top surface 144 extending between the second proximal end 140 and the second free end 142. The second main arm 136 is connected at the second proximal end 140 to the second pivotal mount 122 of the link bracket 112 (as described above with regard to FIG. 12), such that the second main arm 136 is pivotable about the second pivotal mount 122 in the vertical plane to allow variance of a second arm angle Θ₂ between the second main arm axis 138 and the secondary mast axis 110. As best seen in FIG. 7A, the main arms 124, 136 each define longitudinal grooves therein, including at least an upper longitudinal groove 127 and a lower longitudinal groove 129. The grooves 127,129 accommodate pivot assemblies in a manner to be described with regard to FIG. 13.

A first pivot assembly 146 is selectively positionable on the first top surface 132 of the first main arm 124. The first pivot assembly 146 provides a pivotal connection between the first main arm 124 and a first auxiliary arm 148. Details concerning main arm pivot assemblies are discussed herein with regard to FIG. 13. The first auxiliary arm 148 defines a first auxiliary axis 150, a first auxiliary proximal end 152, a first auxiliary distal end 154 opposite the first auxiliary proximal end 152, and a first auxiliary outer surface 156 extending between the first auxiliary proximal end 152 and the first auxiliary distal end 154. The first auxiliary proximal end 152 is mounted to the first pivot assembly 146 such that the first auxiliary arm 148 is pivotable about the first pivot assembly 146 in the vertical plane to allow variance of a first auxiliary angle Θ₃ between the first auxiliary axis 150 and the first main arm axis 126.

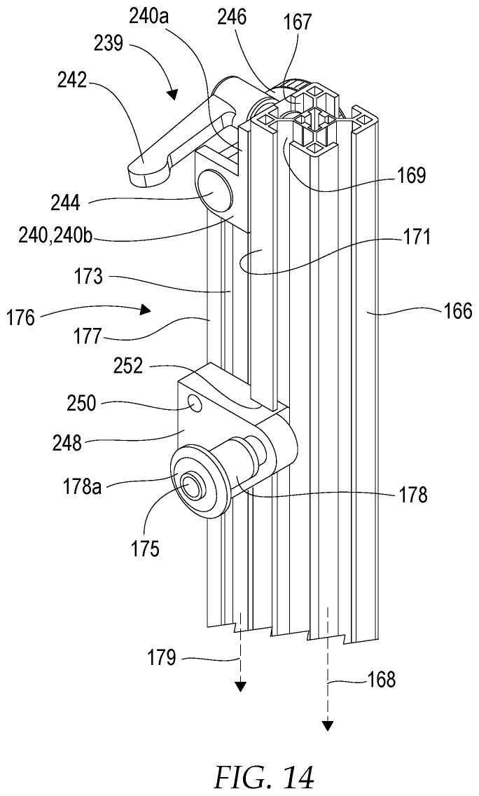

A first target mount assembly 158 may be selectively positionable on the first auxiliary outer surface 156. The first target mount assembly 158 may be configured to support a calibration target, such as calibration target 20, 22, by engaging a first portion of the calibration target. For example, the first target mount assembly 158 can include a first pin 162 projecting outwardly from a bearing in the first target mount assembly 158. Additional details concerning the target mount assemblies of the target calibration stand 100 are discussed herein with regard to FIG. 14. The stand 100 can further comprise a second pivot assembly 164 selectively positionable on the second top surface 144 of the second main arm 136. The second pivot assembly 164 provides a pivotal connection between the second main arm 136 and a second auxiliary arm 166 constructed substantially identically to the first auxiliary arm 148. The second auxiliary arm 166 defines a second auxiliary axis 168, a second auxiliary proximal end 170, a second auxiliary distal end 172 opposite the second auxiliary proximal end 170, and a second auxiliary outer surface 174 extending between the second auxiliary proximal end 170 and the second auxiliary distal end 172. The second auxiliary proximal end 170 is mounted to the second pivot assembly 164 such that the second auxiliary arm 166 is pivotable about the second pivot assembly 164 in the vertical plane to allow variance of a second auxiliary angle Θ₄ between the second auxiliary axis 168 and the second main arm axis 138. A second target mount assembly 176 may be selectively positionable on the second auxiliary outer surface 174. The second target mount assembly 176 may be configured to support a calibration target, such as calibration target 20, 22, by engaging a second portion of the calibration target. For example, the second target mount assembly 176 can include a second pin 178 projecting outwardly from a bearing in the second target mount assembly 176.

Still referring to FIG. 8, the first main arm 124 may further define a first bottom surface 180 opposite the first top surface 132. A third pivot assembly 182 may be selectively positionable on the first bottom surface 180. The target calibration stand 100 may further comprise a third auxiliary arm 184 constructed substantially identically to the first auxiliary arm 148 and the second auxiliary arm 166. The third auxiliary arm 184 defines a third auxiliary axis 186, a third auxiliary proximal end 190, a third auxiliary distal end 192 opposite the third auxiliary proximal end 190, and a third auxiliary outer surface 194 extending between the third auxiliary proximal end 190 and the third auxiliary distal end 192. The third auxiliary proximal end 190 is mounted to the third pivot assembly 182 such that the third auxiliary arm 184 is pivotable about the third pivot assembly 182 in the vertical plane to allow variance of a third auxiliary angle Θ₅ between the third auxiliary 186 axis and the first main arm axis 126. A third target mount assembly 196 may be selectively positionable on the third auxiliary outer surface 194. The third target mount assembly 196 may be configured to support a calibration target, such as calibration target 20, 22, by engaging a third portion of the calibration target. For example, the third target mount assembly 196 can include a third quick release pin 198 projecting outwardly from a bearing in the third target mount assembly 196.

Again referring to FIG. 8, the second main arm 136 may further define a second bottom surface 200 opposite the second top surface 144. A fourth pivot assembly 202 may be selectively positionable on the second bottom surface 200. The target calibration stand 100 may further comprise a fourth auxiliary arm 204 constructed substantially identically to the first auxiliary arm 148, the second auxiliary arm 166, and the third auxiliary arm 184. The fourth auxiliary arm 204 defines a fourth auxiliary axis 206, a fourth auxiliary proximal end 208, a fourth auxiliary distal end 210 opposite the fourth auxiliary proximal end 208, and a fourth auxiliary outer surface 212 extending between the fourth auxiliary proximal end 208 and the fourth auxiliary distal end 210. The fourth auxiliary proximal end 208 is mounted to the fourth pivot assembly 202 such that the fourth auxiliary arm 204 is pivotable about the fourth pivot assembly 202 in the vertical plane to allow variance of a fourth auxiliary angle Θ₆ between the fourth auxiliary axis 206 and the second main arm axis 138. A fourth target mount assembly 214 may be selectively positionable on the fourth auxiliary outer surface 212. The fourth target mount assembly 214 may be configured to support a calibration target, such as calibration target 20, 22, by engaging a fourth portion of the calibration target. For example, the fourth target mount assembly 214 can include a fourth quick release pin 216 projecting outwardly from a bearing in the fourth target mount assembly 214.

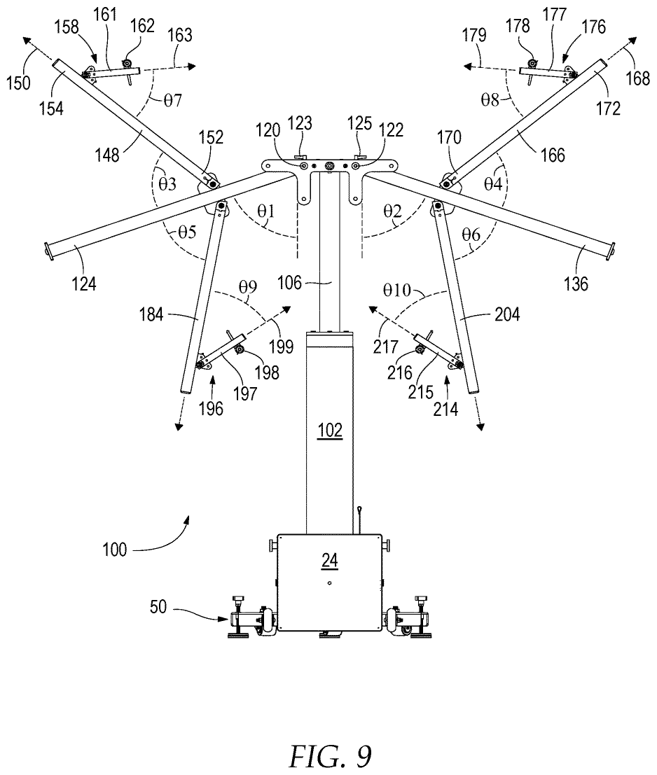

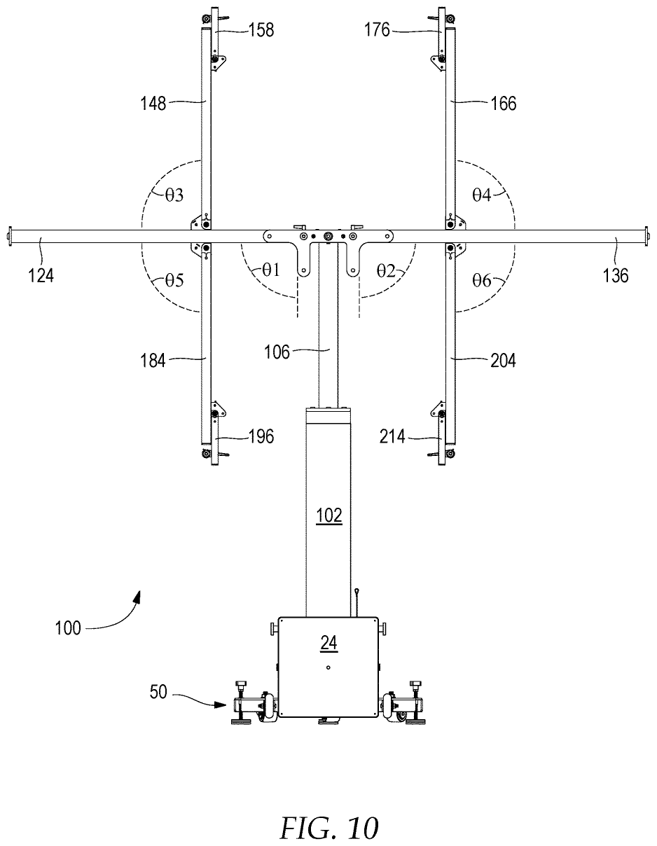

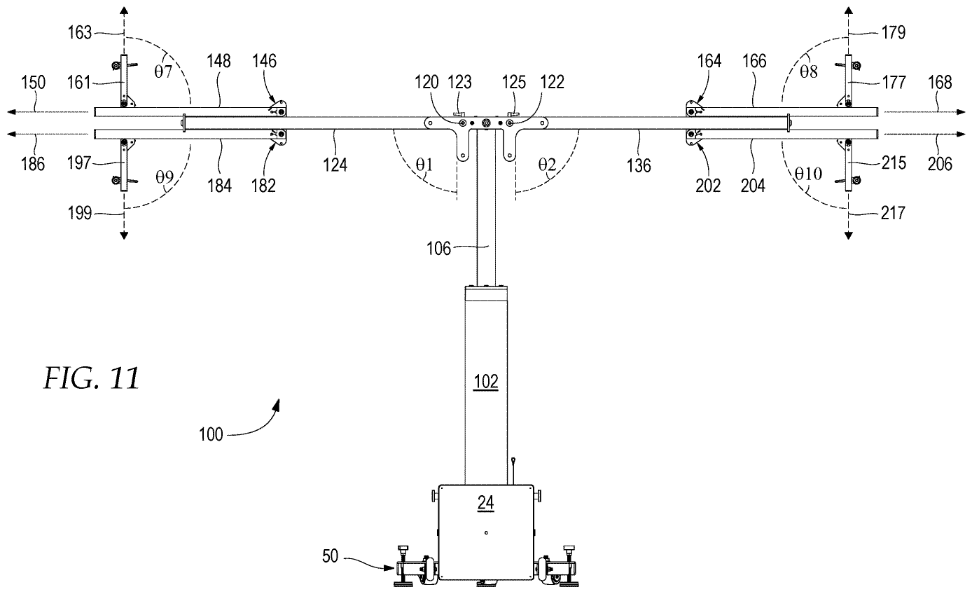

FIG. 9 is a front elevational view of the target calibration stand 100, illustrating the stand 100 in a further partially opened position compared to that of FIG. 8. In particular, the respective magnitudes of angles Θ₁-Θ₈ in FIG. 9 are greater than the counterpart magnitudes of angles Θ₁-Θ₈ in FIG. 8. The target mount assemblies 158, 176,196,214 are shown in FIG. 9 to have respective bars 161,177,197,215 with respective longitudinal bar axes 163,179,199,217, each of the bars 161,177,197,215 being pivotable with respect to their associated auxiliary arms 148,166,184,204. In particular, the first bar 161 of the first target mount assembly 158 can be pivoted such that its axis 163 is oriented at a first bar angle Θ₇ with respect to the first auxiliary axis 150 of the first auxiliary arm 148; the second bar 177 of the second target mount assembly 176 can be pivoted such that its longitudinal bar axis 179 is oriented at a second bar angle Θ₈ with respect to the second auxiliary axis 168 of the second auxiliary arm 166; the third bar 197 of the third target mount assembly 196 can be pivoted such that its axis 199 is oriented at a third bar angle Θ₉ with respect to the third auxiliary axis 186 of the third auxiliary arm 184; and the fourth bar 215 of the fourth target mount assembly 214 can be pivoted such that its axis 217 is oriented at a fourth bar angle Θ₁₀ with respect to the fourth auxiliary axis 206 of the fourth auxiliary arm 204. Additional details concerning the target mount assemblies 158,176,196,214 are discussed herein with regard to FIG. 14. Even though FIG. 9 illustrates the respective bars 161,177,197,215 of the target mount assemblies 158, 176,196,214 oriented in the angled positions shown, the bars 161,177,197,215 need not be pivoted to such positions for all purposes. For instance, while such pivoting is useful when it is desired for the target calibration stand 100 to transition to the second fully-opened configuration to be described with reference to FIG. 11, such pivoting is not needed if it is instead desired for the target calibration stand 100 to transition to the first fully-opened configuration illustrated in FIG. 10, described below.

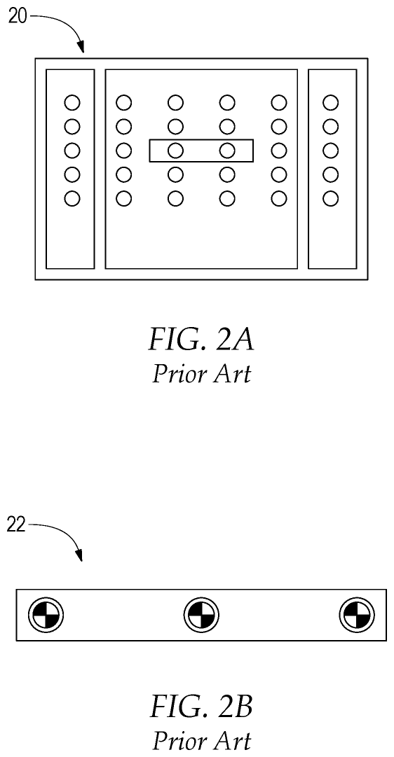

FIG. 10 illustrates the target calibration stand 100 in a first fully-opened position, defined by the magnitudes of angles Θ₁-Θ₆ being, or approximating, 90°. The configuration of FIG. 10 is useful for holding targets, such as target 20 (FIG. 2A), that have a shape in which a length of one side of the target 20 is not substantially larger than a length of an adjoining side of the target. In addition, the height at which a target is mounted to the target calibration stand 100 above a floor may be adjusted by changing the length that the secondary mast 106 telescopically extends from the main mast 102. In the configuration of FIG. 10, the respective bars 161,177, 197,215 of the target mount assemblies 158, 176,196,214 remain in a closed position, meaning that the bars 161,177,197,215 are not oriented at any angles greater than zero with respect to their associated auxiliary arms 148,166,184,204.

FIG. 11 illustrates the target calibration stand 100 in a second fully-opened position. The configuration of FIG. 11 is useful for holding targets, such as target 22 (FIG. 2B), that have a shape in which a length of one side of the target is substantially larger than a length of an adjoining side of the target. In the position shown, the magnitudes of bar angles Θ₇-Θ₁₀ (introduced in FIG. 9) are, or approximate, 90°. Although the first arm angle Θ₁ and the second arm angle Θ₂ both remain substantially right angles, FIG. 11 does not show the auxiliary angles Θ₃-Θ₆ appearing in FIGS. 8-10 because those auxiliary angles all substantially measure zero degrees. In other words, the auxiliary axes 150,186 are substantially parallel to the first main arm axis 126 (FIG. 8) of the first main arm 124, and the auxiliary axes 168,206 are substantially parallel to the second main arm axis 138 (FIG. 8) of the second main arm 136.

FIG. 13 is a detail view of the second pivot assembly 164 and the fourth pivot assembly 202. The construction of these pivot assemblies 164, 202 is likewise intended to reflect the construction of the first pivot assembly 146 and the third pivot assembly 182 (FIG. 8).

The second pivot assembly 164 may comprise an anchor plate 218 formed from a web portion 218a and a pair of spaced flange portions 218b extending upwardly from the web portion 218a. A flange portion eyelet (not shown) may be defined into each of the flange portions 218b. The web portion 218a may define an aperture (not shown) suitably sized to accommodate a tensioning member 220. The web portion 218a may also have a tongue (not shown) that extends inwardly into the upper longitudinal groove 127 of the second main arm 136 to guide the anchor plate 218 as it is selectively longitudinally moved along the top surface 144 of the second main arm 136 in a direction parallel to the second main arm axis 138. The tensioning member 220 may be externally threaded to cooperate with internal threads of a lever member 222, such that rotation of the lever member 222 in one direction causes the tensioning member 220 to fix the second pivot assembly 164 at a selected position along the length of the second main arm 136, while rotation of the lever member 222 in the opposite direction allows the above-described longitudinal movement of the second pivot assembly 164. Optionally, a spring lock washer (not shown) may be positioned between the lever member 222 and an upper surface of the web portion 218a. A collar 224 may receive the second auxiliary proximal end 170 (FIG. 8) of the second auxiliary arm 166. Collar 224 may define one or more apertures (not shown) that axially align with the flange portion eyelets defined into the flange portions 218b of the anchor plate 218. A threaded bolt (not shown) may extend through the flange portion eyelets and through the collar 224, to be received by a socket 226. In this manner, the collar 224, and thus the second auxiliary arm 166, are pivotable about the axis of the threaded bolt. A thumbscrew wheel 228 may be attached to the end of the threaded bolt opposite the socket 226. Turning the thumbscrew wheel 228 in one direction causes threaded bolt to fix the collar 224, and thus the second auxiliary arm 166, at a selected rotational position about the axis of the threaded bolt, while turning the thumbscrew wheel 228 in the opposite direction allows the above-described pivotal movement of the second auxiliary arm 166.

Still referring to FIG. 13, the fourth pivot assembly 202 may comprise an anchor plate 230 formed from a web portion 230a and a pair of spaced flange portions 230b extending upwardly from the web portion 230a. A flange portion eyelet (not shown) may be defined into each of the flange portions 230b. The web portion 230a may define an aperture (not shown) suitably sized to accommodate a tensioning member (not shown). The web portion 230a may also have a tongue (not shown) that extends inwardly into the lower longitudinal groove 129 (FIG. 7A) of the second main arm 136 to guide the anchor plate 230 as it is selectively longitudinally moved along the second bottom surface 200 (FIG. 8) of the second main arm 136 in a direction parallel to the second main arm axis 138. The tensioning member may be externally threaded to cooperate with internal threads of a lever member 232, such that rotation of the lever member 232 in one direction causes the tensioning member to fix the fourth pivot assembly 202 at a selected position along the length of the second main arm 136, while rotation of the lever member 232 in the opposite direction allows the above-described longitudinal movement of the fourth pivot assembly 202. Optionally, a spring lock washer (not shown) may be positioned between the lever member 232 and an upper surface of the web portion 230a. A collar 234 may receive the fourth auxiliary proximal end 208 (FIG. 8) of the fourth auxiliary arm 204. Collar 234 may define one or more apertures (not shown) that axially align with the flange portion eyelets defined into the flange portions 230b of the anchor plate 230. A threaded bolt (not shown) may extend through the flange portion eyelets and through the collar 234, to be received by a socket 236. In this manner, the collar 234, and thus the fourth auxiliary arm 204, are pivotable about the axis of the threaded bolt. A thumbscrew wheel 238 may be attached to the end of the threaded bolt opposite the socket 236. Turning the thumbscrew wheel 238 in one direction causes threaded bolt to fix the collar 234, and thus the fourth auxiliary arm 204, at a selected rotational position about the axis of the threaded bolt, while turning the thumbscrew wheel 238 in the opposite direction allows the above-described pivotal movement of the fourth auxiliary arm 204.

FIG. 14 is a detail view of the second target mount assembly 176. The structure and functionality of the second target mount assembly 176 described herein likewise describe the structure and functionality of the remaining target mount assemblies 158,196, 214 (FIG. 8). The second target mount assembly 176 is depicted in relation to the second auxiliary arm 166, which defines the second auxiliary arm axis 168 and a plurality of longitudinal grooves extending in substantially parallel relation to the axis 168, including an upper longitudinal groove 167 and a side longitudinal groove 169. The longitudinal grooves of the second auxiliary arm 166, in turn, define a plurality of longitudinal flanges, including a side longitudinal flange 171. The second target mount assembly 176 comprises a bar 177 that may have a cross sectional shape resembling that of the second auxiliary arm 166, such that the bar 177 may likewise define a plurality of longitudinal grooves such as a side longitudinal bar groove 173. The second target mount assembly 176 may be provided with a pivot assembly 239 constructed substantially as discussed with regard to the second pivot assembly 164 and the fourth pivot assembly 202 (FIG. 13). Thus, the pivot assembly 239 may comprise an anchor plate 240 formed from a web portion 240a and a pair of spaced flange portions 240b extending upwardly from the web portion 240a. A flange portion eyelet (not shown) may be defined into each of the flange portions 240b. The web portion 240a may define an aperture (not shown) suitably sized to accommodate a tensioning member (not shown). The web portion 240a may also have a tongue (not shown) that extends inwardly into the upper longitudinal groove 167 of the second auxiliary arm 166 to guide the anchor plate 240 as it is selectively positioned on (longitudinally moveable along) the second auxiliary surface 174 (FIG. 8) of the second auxiliary arm 166 in a direction along the longitudinal bar axis 179. The tensioning member may be externally threaded to cooperate with internal threads of a lever member 242, such that rotation of the lever member 242 in one direction causes the tensioning member to fix the pivot assembly 239 at a selected position along the length of the bar 177, while rotation of the lever member 242 in the opposite direction allows the above-described longitudinal movement of the pivot assembly 239. Optionally, a spring lock washer (not shown) may be positioned between the lever member 242 and an upper surface of the web portion 240a. A collar (not shown) may receive a proximal end of bar 177 and may define one or more apertures (not shown) that axially align with the flange portion eyelets defined into the flange portions 240b of the anchor plate 240. A threaded bolt (not shown) may extend through the flange portion eyelets and through the collar, to be received by a socket 244. In this manner, the collar, and thus the bar 177, are pivotable about the axis of the threaded bolt. A thumbscrew wheel 246 may be attached to the end of the threaded bolt opposite the socket 244. Turning the thumbscrew wheel 246 in one direction causes threaded bolt to fix the collar, and thus the bar 177, at a selected rotational position about the axis of the threaded bolt, while turning the thumbscrew wheel 246 in the opposite direction allows the above-described pivotal movement of the bar 177.

Still referring to FIG. 14, the second target mount assembly 176 may also comprise a quick-release pin 178 mounted in a pin bearing 248 that may take the form of a block in which are formed one or more fastener apertures 250 (only one shown), a pin aperture (not shown) through which the quick-release pin 178 extends, and a groove 252 configured to straddle the side longitudinal flange 171 of the second auxiliary arm 166. Each fastener extending through a respective aperture 250 attaches the pin bearing 248 to the bar 177 of the target mount assembly 176. A lower end of the quick-release pin 178 may be provided with a latch (not shown) that engages the side longitudinal groove 169 of the second auxiliary arm 166 to secure the pin bearing 248 to the second auxiliary arm 166. Such a latching arrangement acts as an additional restraint against unwanted rotation of the bar 177 with respect to the second auxiliary arm 166 when, for example, a user wants to configure the target calibration stand 100 to assume the first open position depicted in FIG. 10. Quick-release pin 178 is further provided with a head 178a and a release button 175 concentrically mounted with respect to the head 178a. The release button 175 may be mechanically interconnected to the latching mechanism at the lower end (not shown) of the quick-release pin 178, such that depressing the release button 175 disengages the latch from the side longitudinal groove 169 of the second auxiliary arm 166. Such disengagement permits rotation of the bar 177, provided that the thumbscrew wheel 246 is turned in such a manner as to release any tension that would inhibit rotation of the bar 177. Thus, when the bar 177 undergoes such rotation, the pin bearing 248, and thus the quick-release pin 178, moves with the bar 177, as exemplified in FIG. 9.

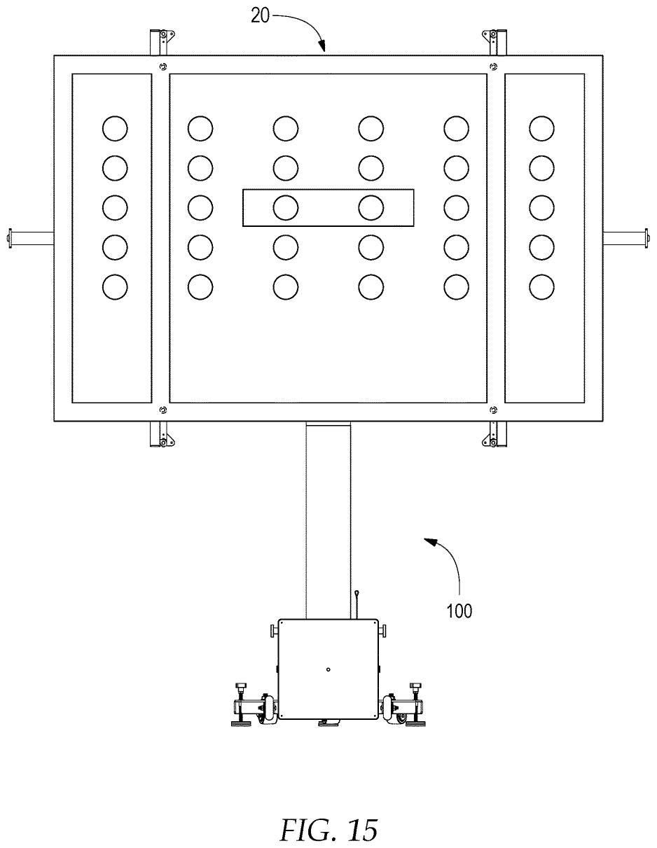

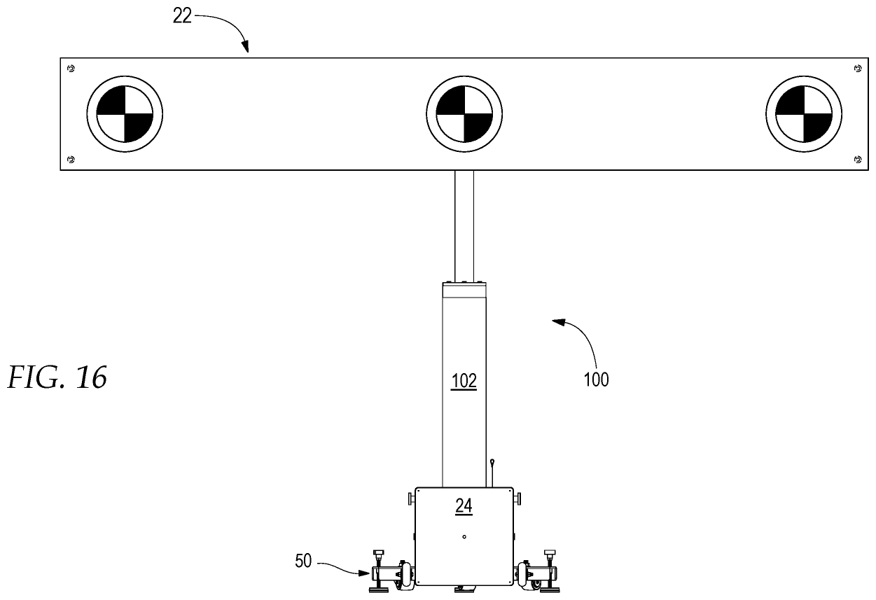

Given the above-described structure and functionality of the target calibration stand 100, it is apparent that the target calibration stand can be used to sequentially support a variety of different calibration targets, such as, for example, a first calibration target (such as target 20 of FIG. 2A) for a first calibration session and a then second calibration target (such as target 22 of FIG. 2B) for a second calibration session, wherein a configuration of the second calibration target 22 differs from a configuration of the first calibration target 20. Such a method may include the steps listed below, it being understood that departure from the particular sequence herein described, and the addition of other steps, are contemplated as being within the scope of the present disclosure if doing so still attains the benefits provided by the target calibration stand 100.
1. Adjusting a height of the calibration stand 100 by telescopically moving the secondary mast 106 in a vertical direction with respect to the main mast 102 until the target calibration stand 100 reaches a first height specified by a manufacturer of a first vehicle to undergo calibration in the first calibration session;
2. Positioning the first main arm 124 and the second main arm 136 so that the first arm angle Θ₁ and the second arm angle Θ₂ each measure about ninety degrees;
3. Positioning the first auxiliary arm 148 and the second auxiliary arm 166 so that the first auxiliary angle Θ₃ and the second auxiliary angle Θ₄ each measure about ninety degrees (as illustrated in FIG. 10);
4. Mounting the first calibration target 20 onto the first target mount assembly 158 and onto the second target mount assembly 176 (FIG. 15);
5. Positioning the third auxiliary arm 184 and the fourth auxiliary arm 204 so that the third auxiliary angle Θ₅ and the fourth auxiliary angle Θ₆ each measure about ninety degrees (as illustrated in FIG. 10);
6. Mounting the first calibration target 20 onto the third target mount assembly 196 and onto the fourth target mount assembly 214 (FIG. 15);
7. Removing the first calibration target 20 from the target calibration stand 100;
8. Determining whether the target calibration stand 100 must be adjusted from the first height to a second height specified by a second manufacturer of a vehicle to undergo calibration in the second calibration session;
9. Responsive to a determination that adjustment from the first height to the second height is required, adjusting the height of the target calibration stand 100 by telescopically moving the secondary mast 106 in a vertical direction with respect to the main mast 102 until the target calibration stand 100 reaches the second height;
10. Positioning the first auxiliary arm 148 and the second auxiliary arm 166 so that the first auxiliary angle Θ₃ and the second auxiliary angle Θ₄ each measure about zero degrees (as illustrated in FIG. 11); and
11. Mounting the second calibration target 22 onto the first target mount assembly 158 and onto the second target mount assembly 176 (FIG. 16).

Another method of using the target calibration stand 100 contemplates sequentially supporting the calibration target 22 for a first calibration session and then the calibration target 20 for a second calibration session. In this scenario, a series of steps would involve reversing the above-described steps in which certain arms are moved, such that this other method contemplates the following steps, with the understanding additional steps can also be implemented in this scenario to attain the desired adjustment results.
1. Adjusting a height of the calibration stand 100 by telescopically moving the secondary mast 106 in a vertical direction with respect to the main mast 102 until the target calibration stand 100 reaches a first height specified by a manufacturer of a vehicle to undergo calibration in the first calibration session;
2. Positioning the first main arm 124 and the second main arm 136 so that the first arm angle Θ₁ and the second arm angle Θ₂ each measure about ninety degrees;
3. Positioning the first auxiliary arm 148 and the second auxiliary arm 166 so that the first auxiliary angle Θ₃ and the second auxiliary angle Θ₄ each measure about zero degrees;
4. Mounting the calibration target 22 onto the first target mount assembly 158 and onto the second target mount assembly 176 (FIG. 16);
5. Removing the calibration target 22 from the target calibration stand 100;
6. Positioning the first auxiliary arm 148 and the second auxiliary arm 166 so that the first auxiliary angle Θ₃ and the second auxiliary angle Θ₄ each measure about ninety degrees; and
7. Mounting the calibration target 20 onto the first target mount assembly 158 and onto the second target mount assembly 176 (FIG. 15).

One should note that conditional language, such as, among others, “can,” “could,” “might,” or “may,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily comprise logic for deciding, with or without user input or prompting, whether these features, elements and/or steps are included or are to be performed in any particular aspect.

It should be emphasized that the above-described aspects are merely possible examples of implementations, merely set forth for a clear understanding of the principles of the present disclosure. Any process descriptions or blocks in flow diagrams should be understood as representing modules, segments, or portions of code which comprise one or more executable instructions for implementing specific logical functions or steps in the process, and alternate implementations are included in which functions may not be included or executed at all, can be executed out of order from that shown or discussed, including substantially concurrently or in reverse order, depending on the functionality involved, as would be understood by those reasonably skilled in the art of the present disclosure. Many variations and modifications can be made to the above-described aspect(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

1. A target calibration stand, comprising:
a vertically disposed telescoping mast, the mast defining a mast axis;
a link bracket connected to an upper end of the mast, the link bracket defining a first pivotal mount proximate a link bracket first end and a second pivotal mount proximate a link bracket second end;
a first main arm, the first main arm defining a first main arm axis, a first proximal end, a first free end opposite the first proximal end, and a first top surface extending between the first proximal end and the first free end, the first main arm connected at the first proximal end to the first pivotal mount of the link bracket, wherein the first main arm is pivotable about the first pivotal mount in a vertical plane to allow variance of a first arm angle between the first main arm axis and the mast axis;
a second main arm, the second main arm defining a second main arm axis, a second proximal end, a second free end opposite the second proximal end, and a second top surface extending between the second proximal end and the second free end, the second main arm connected at the second proximal end to the second pivotal mount of the link bracket, wherein the second main arm is pivotable about the second pivotal mount in the vertical plane to allow variance of a second arm angle between the second main arm axis and the mast axis;
a first pivot assembly, the first pivot assembly selectively positionable on the first top surface of the first main arm;
a first auxiliary arm, the first auxiliary arm defining a first auxiliary axis, a first auxiliary proximal end, a first auxiliary distal end opposite the first auxiliary proximal end, and a first auxiliary outer surface extending between the first auxiliary proximal end and the first auxiliary distal end, the first auxiliary proximal end mounted to the first pivot assembly such that the first auxiliary arm is pivotable about the first pivot assembly in the vertical plane to allow variance of a first auxiliary angle between the first auxiliary axis and the first main arm axis;
a first target mount assembly, the first target mount assembly selectively positionable on the first auxiliary outer surface, the first target mount assembly configured to support a calibration target by engaging a first portion of the calibration target;
a second pivot assembly, the second pivot assembly selectively positionable on the second top surface of the second main arm;
a second auxiliary arm, the second auxiliary arm defining a second auxiliary axis, a second auxiliary proximal end, a second auxiliary distal end opposite the second auxiliary proximal end, and a second auxiliary outer surface extending between the second auxiliary proximal end and the second auxiliary distal end, the second auxiliary proximal end mounted to the second pivot assembly such that the second auxiliary arm is pivotable about the second pivot assembly in the vertical plane to allow variance of a second auxiliary angle between the second auxiliary axis and the second main arm axis; and
a second target mount assembly, the second target mount assembly selectively positionable on the second auxiliary outer surface, the second target mount assembly configured to support the calibration target by engaging a second portion of the calibration target.

2. The target calibration stand of claim 1, wherein the first main arm further defines a first bottom surface opposite the first top surface, and wherein the target calibration stand further comprises:
a third pivot assembly, the third pivot assembly selectively positionable on the first bottom surface of the first main arm;
a third auxiliary arm, the third auxiliary arm defining a third auxiliary axis, a third auxiliary proximal end, a third auxiliary distal end opposite the third auxiliary proximal end, and a third auxiliary outer surface extending between the third auxiliary proximal end and the third auxiliary distal end, the third auxiliary proximal end mounted to the third pivot assembly such that the third auxiliary arm is pivotable about the third pivot assembly in the vertical plane to allow variance of a third auxiliary angle between the third auxiliary axis and the first main arm axis; and
a third target mount assembly, the third target mount assembly selectively positionable on the third auxiliary outer surface, the third target mount assembly configured to support the calibration target by engaging a third portion of the calibration target.

3. The target calibration stand of claim 2, wherein the second main arm further defines a second bottom surface opposite the second top surface, and wherein the target calibration stand further comprises:
a fourth pivot assembly, the fourth pivot assembly selectively positionable on the second bottom surface of the second main arm;
a fourth auxiliary arm, the fourth auxiliary arm defining a fourth auxiliary axis, a fourth auxiliary proximal end, a fourth auxiliary distal end opposite the fourth auxiliary proximal end, and a fourth auxiliary outer surface extending between the fourth auxiliary proximal end and the fourth auxiliary distal end, the fourth auxiliary proximal end mounted to the fourth pivot assembly such that the fourth auxiliary arm is pivotable about the fourth pivot assembly in the vertical plane to allow variance of a fourth auxiliary angle between the fourth auxiliary axis and the second main arm axis; and
a fourth target mount assembly, the fourth target mount assembly selectively positionable on the fourth auxiliary outer surface, the fourth target mount assembly configured to support the calibration target by engaging a fourth portion of the calibration target.

4. The target calibration stand of claim 3, wherein at least one of the first target mount assembly, second target mount assembly, third target mount assembly, and fourth target mount assembly comprises:
a pin bearing; and
a quick release pin mounted in the bearing, the quick release pin configured to engage a portion of the calibration target.

5. A method of using the target calibration stand of claim 1 to sequentially support a first calibration target for a first calibration session and a then second calibration target for a second calibration session, wherein a configuration of the second calibration target differs from a configuration of the first calibration target, the method comprising the steps of:
adjusting a height of the target calibration stand until the target calibration stand reaches a first height specified by a manufacturer of a vehicle to undergo calibration in the first calibration session;
positioning the first main arm and the second main arm so that the first arm angle and the second arm angle each measure about ninety degrees;
positioning the first auxiliary arm and the second auxiliary arm so that the first auxiliary angle and the second auxiliary angle each measure about ninety degrees;
mounting the first calibration target onto the first target mount assembly and onto the second target mount assembly;
removing the first calibration target from the target calibration stand;
positioning the first auxiliary arm and the second auxiliary arm so that the first auxiliary angle and the second auxiliary angle each measure about zero degrees; and
mounting the second calibration target onto the first target mount assembly and onto the second target mount assembly.

6. The method of claim 5, wherein the manufacturer is a first manufacturer, and further comprising the steps of, after the step of removing the first calibration target from the target stand:
determining whether the target calibration stand must be adjusted from the first height to a second height specified by a second manufacturer of a vehicle to undergo calibration in the second calibration session; and
responsive to a determination that adjustment from the first height to the second height is required, adjusting the height of the target calibration stand until the target calibration stand reaches the second height.

7. A method of using the target calibration stand of claim 1 to sequentially support a first calibration target for a first calibration session and a then second calibration target for a second calibration session, wherein a configuration of the second calibration target differs from a configuration of the first calibration target, the method comprising the steps of:
adjusting a height of the target calibration stand until the target calibration stand reaches a first height specified by a manufacturer of a vehicle to undergo calibration in the first calibration session;
positioning the first main arm and the second main arm so that the first arm angle and the second arm angle each measure about ninety degrees;
positioning the first auxiliary arm and the second auxiliary arm so that the first auxiliary angle and the second auxiliary angle each measure about zero degrees;
mounting the first calibration target onto the first target mount assembly and onto the second target mount assembly;
removing the first calibration target from the target calibration stand;
positioning the first auxiliary arm and the second auxiliary arm so that the first auxiliary angle and the second auxiliary angle each measure about ninety degrees; and
mounting the second calibration target onto the first target mount assembly and onto the second target mount assembly.

8. A target calibration stand, comprising:
a main mast, the main mast defining a cavity;
a secondary mast slidably received within the cavity of the main mast, the secondary mast defining an upper end and a secondary mast axis;
a link bracket defining a first end, an opposed second end, and a body portion disposed between the first end and the second end, the body portion connected to the upper end of the secondary mast, the link bracket defining a first pivotal mount proximate the first end and a second pivotal mount proximate the second end;
a first main arm, the first main arm defining a first main arm axis, a first proximal end, a first free end opposite the first proximal end, and a first top surface extending between the first proximal end and the first free end, the first main arm connected at the first proximal end to the first pivotal mount of the link bracket, wherein the first main arm is pivotable about the first pivotal mount in a vertical plane to allow variance of a first arm angle between the first main arm axis and the secondary mast axis;
a second main arm, the second main arm defining a second main arm axis, a second proximal end, a second free end opposite the second proximal end, and a second top surface extending between the second proximal end and the second free end, the second main arm connected at the second proximal end to the second pivotal mount of the link bracket, wherein the second main arm is pivotable about the second pivotal mount in the vertical plane to allow variance of a second arm angle between the second main arm axis and the secondary mast axis;
a first pivot assembly, the first pivot assembly selectively positionable on the first top surface of the first main arm;
a first auxiliary arm, the first auxiliary arm defining a first auxiliary axis, a first auxiliary proximal end, a first auxiliary distal end opposite the first auxiliary proximal end, and a first auxiliary outer surface extending between the first auxiliary proximal end and the first auxiliary distal end, the first auxiliary proximal end mounted to the first pivot assembly such that the first auxiliary arm is pivotable about the first pivot assembly in the vertical plane to allow variance of a first auxiliary angle between the first auxiliary axis and the first main arm axis;
a first target mount assembly, the first target mount assembly selectively positionable on the first auxiliary outer surface, the first target mount assembly configured to support a calibration target by engaging a first portion of the calibration target;
a second pivot assembly, the second pivot assembly selectively positionable on the second top surface of the second main arm;
a second auxiliary arm, the second auxiliary arm defining a second auxiliary axis, a second auxiliary proximal end, a second auxiliary distal end opposite the second auxiliary proximal end, and a second auxiliary outer surface extending between the second auxiliary proximal end and the second auxiliary distal end, the second auxiliary proximal end mounted to the second pivot assembly such that the second auxiliary arm is pivotable about the second pivot assembly in the vertical plane to allow variance of a second auxiliary angle between the second auxiliary axis and the second main arm axis; and
a second target mount assembly, the second target mount assembly selectively positionable on the second auxiliary outer surface, the second target mount assembly configured to support the calibration target by engaging a second portion of the calibration target.

9. The target calibration stand of claim 8, wherein the first main arm further defines a first bottom surface opposite the first top surface, and wherein the target calibration stand further comprises:
a third pivot assembly, the third pivot assembly selectively positionable on the first bottom surface of the first main arm;
a third auxiliary arm, the third auxiliary arm defining a third auxiliary axis, a third auxiliary proximal end, a third auxiliary distal end opposite the third auxiliary proximal end, and a third auxiliary outer surface extending between the third auxiliary proximal end and the third auxiliary distal end, the third auxiliary proximal end mounted to the third pivot assembly such that the third auxiliary arm is pivotable about the third pivot assembly in the vertical plane to allow variance of a third auxiliary angle between the third auxiliary axis and the first main arm axis; and
a third target mount assembly, the third target mount assembly selectively positionable on the third auxiliary outer surface, the third target mount assembly configured to support the calibration target by engaging a third portion of the calibration target.

10. The target calibration stand of claim 9, wherein the second main arm further defines a second bottom surface opposite the second top surface, and wherein the target calibration stand further comprises:
a fourth pivot assembly, the fourth pivot assembly selectively positionable on the second bottom surface of the second main arm;
a fourth auxiliary arm, the fourth auxiliary arm defining a fourth auxiliary axis, a fourth auxiliary proximal end, a fourth auxiliary distal end opposite the fourth auxiliary proximal end, and a fourth auxiliary outer surface extending between the fourth auxiliary proximal end and the fourth auxiliary distal end, the fourth auxiliary proximal end mounted to the fourth pivot assembly such that the fourth auxiliary arm is pivotable about the fourth pivot assembly in the vertical plane to allow variance of a fourth auxiliary angle between the fourth auxiliary axis and the second main arm axis; and
a fourth target mount assembly, the fourth target mount assembly selectively positionable on the fourth auxiliary outer surface, the fourth target mount assembly configured to support the calibration target by engaging a fourth portion of the calibration target.

11. The target calibration stand of claim 10, wherein at least one of the first target mount assembly, second target mount assembly, third target mount assembly, and fourth target mount assembly comprises:
a pin bearing; and
a quick release pin mounted in the bearing, the quick release pin configured to engage a portion of the calibration target.

12. The target calibration stand of claim 8, wherein at least one of the first pivot assembly and the second pivot assembly comprises:
an anchor plate comprising a web portion and a pair of spaced flange portions extending upwardly from the web portion, wherein the web portion defines a web aperture and each flange portion in the pair of spaced flange portions defining a flange aperture;
a bolt extending through each flange aperture in the pair of spaced flange portions, the bolt defining opposed ends;
a thumbscrew wheel attached to an end of the bolt;
a tensioning member defining an upper end extending through the web aperture; and
a lever member engaging the upper end of the threaded member.

13. The target calibration stand of claim 12, wherein the web portion of the anchor plate further defines an upper surface, and further comprising a spring lock washer positioned between the lever member and the upper surface of the web portion.

14. The target calibration stand of claim 8, wherein the main mast further defines a lower end, and further comprising a base plate assembly receiving the lower end of the main mast.

15. The target calibration stand of claim 14, wherein the base plate assembly comprises:
a polygonal base plate, the polygonal base plate defining at least three vertices and an upper surface;
a caster assembly mounted to each of the vertices of the polygonal base plate;
a base mount attached to the upper surface of the polygonal base plate, the base mount defining an opening configured to receive the lower end of the main mast; and
a locking cam member operably connected to the base mount, the locking cam member configured to engage the main mast when the main mast is inserted into the opening of the base mount.

16. A method of using the target calibration stand of claim 10 to sequentially support a first calibration target for a first calibration session and a then second calibration target for a second calibration session, wherein a configuration of the second calibration target differs from a configuration of the first calibration target, the method comprising the steps of:
adjusting a height of the target calibration stand by telescopically moving the secondary mast in a vertical direction with respect to the main mast until the target calibration stand reaches a first height specified by a manufacturer of a vehicle to undergo calibration in the first calibration session;
positioning the first main arm and the second main arm so that the first arm angle and the second arm angle each measure about ninety degrees;
positioning the first auxiliary arm and the second auxiliary arm so that the first auxiliary angle and the second auxiliary angle each measure about ninety degrees;
mounting the first calibration target onto the first target mount assembly and onto the second target mount assembly;
removing the first calibration target from the target calibration stand;
positioning the first auxiliary arm and the second auxiliary arm so that the first auxiliary angle and the second auxiliary angle each measure about zero degrees; and
mounting the second calibration target onto the first target mount assembly and onto the second target mount assembly.

17. The method of claim 16, further comprising the steps of, prior to removing the first calibration target from the calibration stand:
positioning the third auxiliary arm and the fourth auxiliary arm so that the third auxiliary angle and the fourth auxiliary angle each measure about ninety degrees; and
mounting the first calibration target onto the third target mount assembly and onto the fourth target mount assembly.

18. The method of claim 16, wherein the manufacturer is a first manufacturer, and further comprising the steps of, after the step of removing the first calibration target from the target stand:
determining whether the target calibration stand must be adjusted from the first height to a second height specified by a second manufacturer of a vehicle to undergo calibration in the second calibration session; and
responsive to a determination that adjustment from the first height to the second height is required, adjusting the height of the target calibration stand by telescopically moving the secondary mast in a vertical direction with respect to the main mast until the target calibration stand reaches the second height.

19. A method of using the target calibration stand of claim 8 to sequentially support a first calibration target for a first calibration session and a then second calibration target for a second calibration session, wherein a configuration of the second calibration target differs from a configuration of the first calibration target, the method comprising the steps of:
adjusting a height of the target calibration stand by telescopically moving the secondary mast in a vertical direction with respect to the main mast until the target calibration stand reaches a first height specified by a manufacturer of a vehicle to undergo calibration in the first calibration session;
positioning the first main arm and the second main arm so that the first arm angle and the second arm angle each measure about ninety degrees;
positioning the first auxiliary arm and the second auxiliary arm so that the first auxiliary angle and the second auxiliary angle each measure about zero degrees;
mounting the first calibration target onto the first target mount assembly and onto the second target mount assembly;
removing the first calibration target from the target calibration stand;
positioning the first auxiliary arm and the second auxiliary arm so that the first auxiliary angle and the second auxiliary angle each measure about ninety degrees; and
mounting the second calibration target onto the first target mount assembly and onto the second target mount assembly.
